(19) United States
(12) Patent Application Publication
(10) Pub. No.: US 2011/0139554 A1
(43) Pub. Date: Jun. 16, 2011

(54) BRAKE SYSTEM OF VEHICLE

(75) Inventor: Jongsung KIM, Seoul (KR)

(73) Assignee: HYUNDAI MOBIS CO., LTD., SEOUL (KR)

(21) Appl. No.: 12/884,026

(22) Filed: Sep. 16, 2010

(30) Foreign Application Priority Data
Dec. 10, 2009 (KR) 10-2009-0122521

(51) Int. Cl. F16D 65/36; F16D 55/224; B60T 13/10; F16D 55/226; F16D 65/72

(52) U.S. Cl. 188/71.8; 188/106 P; 188/72.2

(57) ABSTRACT

A brake device includes a brake pad movable toward a brake disc and configured to contact the brake disc, and an EWB device comprising a wedge and an actuator configured to push the wedge. The wedge is configured to push the brake pad when the actuator pushes the wedge. The device has a hydraulic cylinder comprising a piston coupled to and configured to push the EWB device. The wedge is configured to push the brake pad without operation of the actuator when the piston pushes the EWB device such that the brake pad can move toward the brake disc.

### CROSS-REFERENCE TO RELATED APPLICATIONS

The present application claims priority to Korean Patent Application Number 10-2009-0122521 filed Dec. 10, 2009, the entire contents of which application is incorporated herein for all purposes by this reference.

### BACKGROUND

1. Field

The present disclosure relates to a brake system of a vehicle, in detail, a technology associated with an EMB (Electromechanical Brake) that is operated by electronic control.

2. Description of Related Art

It is hard to prepare a motor that is driven at high voltage above 40V to provide large force such that the brake-clamping force required for a common EMB to hold the brake disc is ensured at a level equal to the hydraulic brake systems of the related art.

There is an EWB (Electronic Wedge Brake), a type of the EMB to overcome the problem. As the EWB provides a motor with force making a brake wedge slide on a roller between the brake wedge and a base wedge along a slope toward a brake disc, the brake pad of the brake wedge generates friction force with the brake disc. The friction force causes self-energizing in which the brake wedge is further moved to the brake disc by the slopes of the wedges, such that the motor may have a relatively small capacity to be driven by voltage of about 12V and sufficient clamping-force can be achieved.

The EWB requires an abrasion compensating device adjusting the position of the base wedge relative to the brake disc to compensate abrasion of the brake pad, in which a motor and a plurality of peripheral parts are needed to compensate the abrasion, such that the volume and weight of the EWB increase.

Further, most EMBs, including the EWB, do not have a mechanical emergency braking member, such that it is very difficult to ensure safety.

The information disclosed in this Background section is only for enhancement of understanding the general background of the disclosure and should not be taken as an acknowledgement or any form of suggestion that this information forms the prior art already known to a person skilled in the art.

### SUMMARY

Various aspects of the present invention are directed to provide a brake system of a vehicle which can be manufactured to have relatively small weight and volume by compensating abrasion with simple structure and configuration, and can ensure sufficient safety in braking, by generating a braking force with a mechanical mechanism in an emergency.

An aspect of the present invention provides a brake system of a vehicle, comprising: a caliper body; an EWB actuator mounted on the caliper body to be able to make relative straight motion toward a brake disc; and a hydraulic piston assembly disposed between the caliper body and the EWB actuator to press the brake disc by moving the EWB actuator straight with respect to the caliper body.

Embodiments of the present invention make it possible to achieve a configuration having relatively small weight and volume by compensating abrasion with simple structure and configuration, and to ensure sufficient safety in braking, by generating a braking force with a mechanical mechanism in an emergency.

The methods and apparatuses in the present disclosure have other features and advantages which will be apparent from or are set forth in more detail in the accompanying drawings, which are incorporated herein, and the following Detailed Description of Embodiments, which together serve to explain certain principles or aspects of the present invention.

### BRIEF DESCRIPTION OF THE DRAWINGS

FIG. 1 is a conceptual view illustrating the main configuration of a brake system of a vehicle according to one embodiment of the present invention.

FIG. 2 is a perspective view showing the configuration of FIG. 1.

FIG. 3 is a view with a caliper body removed in FIG. 2.

FIG. 4 is a cross-sectional view taken along line IV-IV of FIG. 3.

FIG. 5 is a view comparing the operations of a brake system according to one embodiment of the present invention.

FIG. 6 is a view showing another embodiment of the present invention.

FIG. 7 is a view showing when hydraulic sensor is disposed in a hydraulic line.

### DETAILED DESCRIPTION OF EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

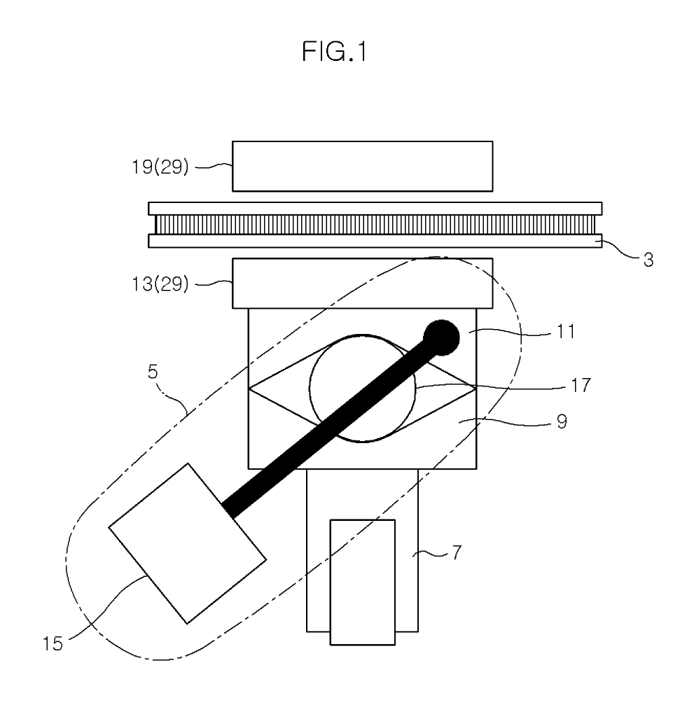

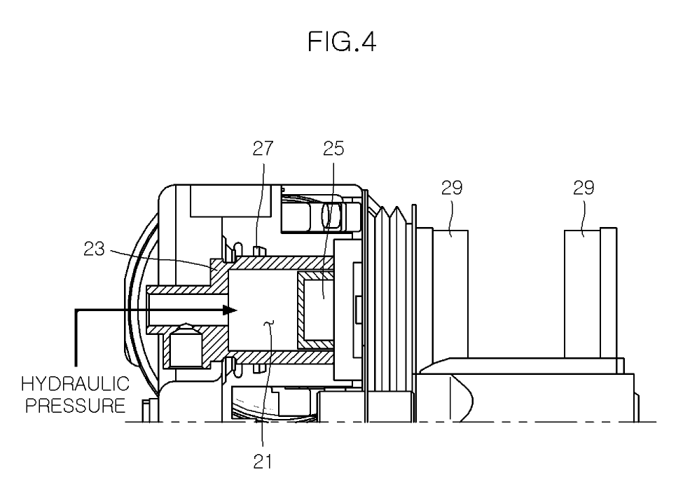

Referring to FIGS. 1 to 5, an embodiment of the present invention includes: a caliper body 1; an EWB actuator 5 mounted on caliper body 1 to be able to make relative straight motion toward a brake disc 3; and a hydraulic piston assembly 7 disposed between caliper body 1 and EWB actuator 5 to press brake disc 3 by moving EWB actuator 5 straight with respect to caliper body 1.

That is, it is possible to compensate abrasion and provide emergency braking force, by mounting the entire configuration of EWB actuator 5 including a base wedge 9, a brake wedge 11, and a device driving brake wedge 11 to be able to move straight with respect to caliper body 1 and by allowing hydraulic piston assembly 7 to control the position of EWB actuator 5 with respect to caliper body 1.

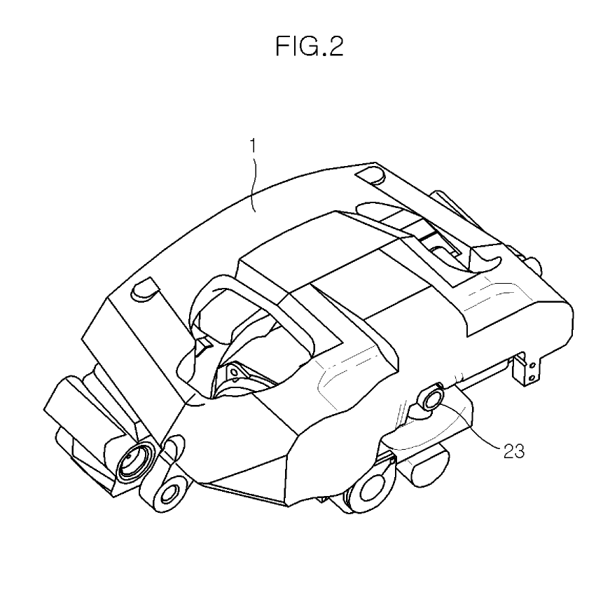

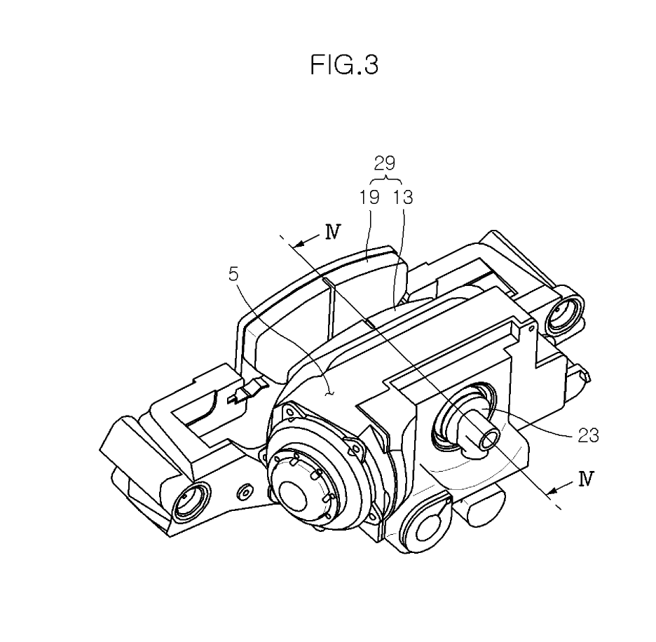

For reference, brake wedge 11 shown in FIG. 1 is connected with an inner pad 13 and a driving motor 15 for driving brake wedge 11, a roller 17 is disposed between brake wedge 11 and base wedge 9, and as shown in FIGS. 2 and 3, one end of caliper body 1 is connected to an outer pad 19 opposite to inner pad 13 and the other end is connected to hydraulic piston assembly 7.

In this embodiment, hydraulic piston assembly 7 includes: a cylinder 23 fixed to caliper body 1, sliding straight with respect to EWB actuator 5, and having a hydraulic chamber 21 where hydraulic pressure supplied from the outside is exerted; a plunger 25 integrally formed with EWB actuator 5 to slide straight by the hydraulic pressure in hydraulic chamber 21 of cylinder 23; and a seal 27 disposed between cylinder 23 and EWB actuator 5.

It should be understood that plunger 25 is arranged to move EWB actuator 5 toward brake disc 3, when hydraulic pressure is supplied to hydraulic chamber 21.

Therefore, when hydraulic pressure is supplied to hydraulic chamber 21, the entire EWB actuator 5 is moved toward brake disc 3 by the pressure applied to plunger 25 and seal 27 absorbs the relative motion.

Seal 27 may be fitted in a seal groove formed at any one of cylinder 23 and EWB actuator 5, and in this embodiment, a seal groove is formed at EWB actuator 5.

Therefore, as EWB actuator 5 is moved toward brake disc 3 by the hydraulic pressure supplied to hydraulic chamber 21 of cylinder 23, seal 27 absorbs relative motion between EWB actuator 5 and cylinder 23 while deforming. Further, when the hydraulic pressure is removed, EWB actuator 5 is moved away from brake disc 3 by elastic restoration of seal 27, such that a gap is defined between brake disc 3 and the EWB actuator.

When brake pad 29 is largely worn and the relative displacement of EWB actuator 5 by the hydraulic pressure supplied to cylinder 23 increases, slide occurs between cylinder 23 and seal 27. Accordingly, EWB actuator 5 remains at the position moving toward brake disc 3 by the frictional amount of brake pad 29, even if EWB actuator 5 is returned by the elastic restoration of seal 27, such that the abrasion of brake pad 29 is naturally compensated.

A hydraulic line 33 is connected to hydraulic chamber 21 of cylinder 23 to supply hydraulic pressure from a hydraulic cylinder 31, which generating hydraulic pressure when a driver presses down the brake pedal, to hydraulic chamber 21 of cylinder 23.

In this configuration, hydraulic cylinder 31, unlike master cylinders of typical hydraulic brake system, has not a plurality of pressure chamber, but only one pressure chamber, and a simple structure composed of a cylinder and a plunger, which generate hydraulic pressure smaller than the master cylinders of the typical hydraulic brake system.

Further, unlike the typical hydraulic brake system, hydraulic cylinder 31 generates hydraulic pressure by only the force applied from the driver's foot, without a brake booster, such that the energy consumed by the engine to operate the brake booster in the typical hydraulic brake system is not needed, the energy for braking is minimized, and the weight is reduce, thereby maintaining the advantages of the EWB system.

In one embodiment, the EWB can perform by itself the ABS (Anti-lock Brake System) and ESC (Electronic Stability Control) functions.

A pedal simulator is connected to the brake pedal transmitting operational force to hydraulic cylinder 31, such that the driver is provided with a sensitive braking response from the brake pedal. Further, it is possible to supply electric signals according to the operational state of the brake pedal to the ECU (Electronic Control Unit) by providing a pedal sensor.

The ECU receives signals from the pedal sensor and transmits information to each wheel ECU to control the braking force, and can control a solenoid valve 35.

That is, a solenoid valve 35 is provided in hydraulic line 33 to open/close hydraulic line 33 and controlled by the ECU, in which solenoid valve 35 is a normally-open type that opens hydraulic line 33, when control current is not supplied.

Therefore, even if control current for controlling solenoid valve 35 is not appropriately supplied by an electrical problem, solenoid valve 35 keeps hydraulic line 33 open; therefore, EWB actuator 5 is pressed against brake disc 3 by the hydraulic pressure generated by hydraulic cylinder 31 when the driver presses down the brake pedal, thereby performing emergency braking.

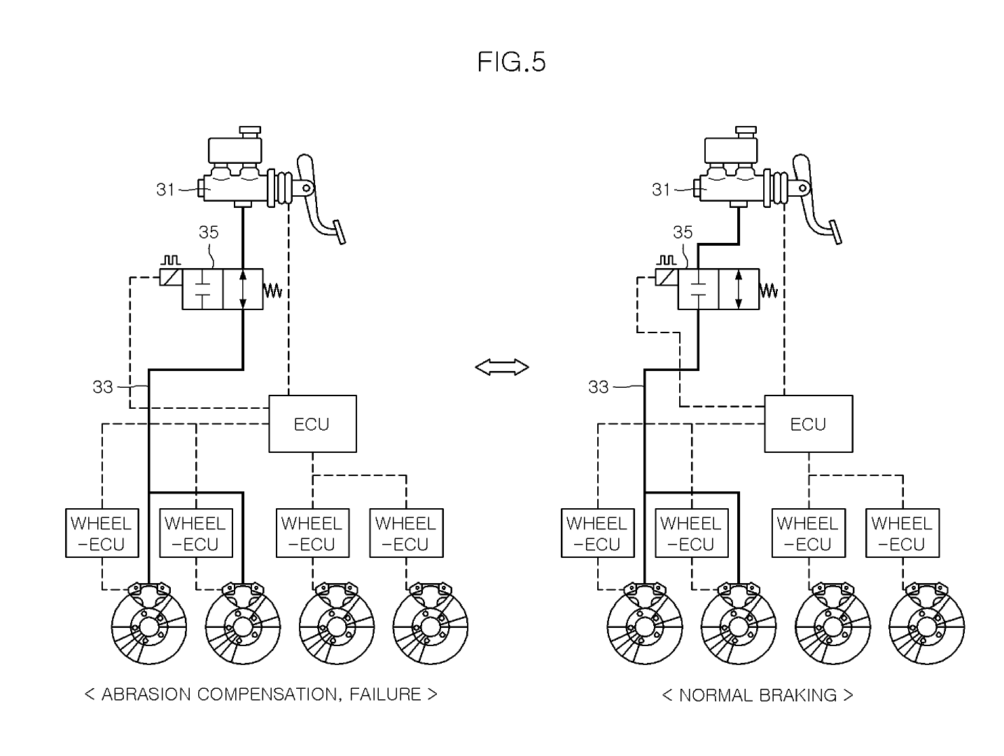

That is, as compared in FIG. 5, when a failure occurs or abrasion of brake pad 29 is compensated, solenoid valve 35 opens hydraulic line 33 and EWB actuator 5 is moved from caliper body 1 toward brake disc 3 by the hydraulic pressure transmitted from hydraulic cylinder 31 when the brake pedal is operated, such that braking force is generated or the abrasion of brake pad 29 is compensated. Further, in normal braking, solenoid valve 35 closes hydraulic line 33, such that hydraulic pressure from hydraulic cylinder 31 is not transmitted and the EWB independently generate braking force for each wheel by the control of the ECU and the wheel ECUs in accordance with the operational state of the brake pedal.

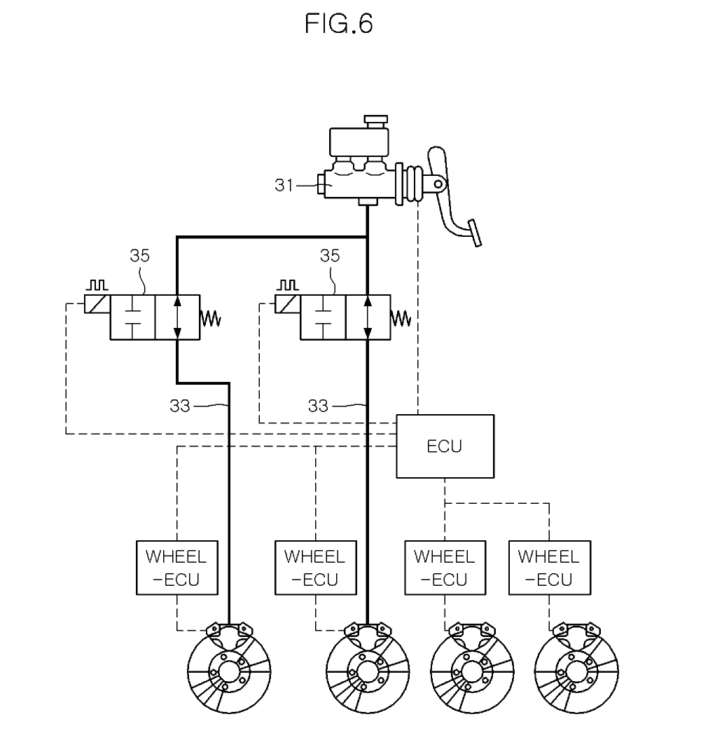

FIG. 6 shows another embodiment of the present invention, in which the hydraulic piston assembly is provided for only the brake mechanisms of both front wheels of all the wheels of a vehicle, the hydraulic line is divided to supply hydraulic pressure from the hydraulic cylinder to the hydraulic piston assembly provided to the brake system of both front wheels of the vehicle, and a solenoid valve is provided in each of the divided hydraulic lines. Therefore, the hydraulic pressures supplied to the hydraulic piston assemblies provided for the brake system of both front wheels of the vehicle can be respectively adjusted, such that it is possible to independently control each wheel in ABS or ESC operation.

The brake system in an embodiment of the present invention may use a hydraulic sensor 36 that senses hydraulic pressure exerted in the hydraulic piston assembly 7, as a sensing member for sensing clamping force pressing the brake disc with the brake pad in braking.

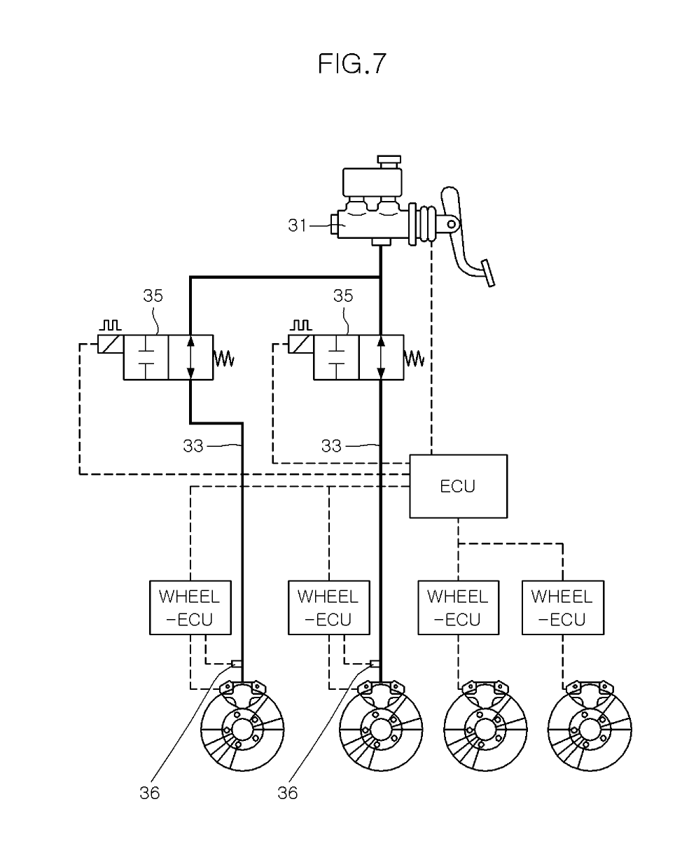

FIG. 7 exemplifies when hydraulic sensor 36 is disposed in a hydraulic line 33, but hydraulic sensor 36 may be installed at any position where it can measure hydraulic pressure exerted in hydraulic piston assembly 7, such as hydraulic chamber 21 of hydraulic piston assembly 7.

It is required to develop and use an independent load sensor for sensing the clamping force in the existing common EMBs or EWBs, because the hydraulic line in one embodiment of the present invention is not provided; however, since it is possible to sense the clamping force with hydraulic sensor 33 measuring the hydraulic pressure exerted in hydraulic piston assembly 7 in the brake system in one embodiment of the present invention, it is possible to use hydraulic sensors where the existing technologies are sufficiently integrated. Further, since the clamping force is sensed while being absorbed by the oil filled in hydraulic chamber 21 of hydraulic piston 7, it is possible to stably sense the clamping force without excessive influence from the external environment.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A brake system of a vehicle, comprising:
a caliper body;
an EWB actuator mounted on the caliper body and capable of making relative straight motion toward a brake disc; and
a hydraulic piston assembly disposed between the caliper body and the EWB actuator to press the brake disc by moving the EWB actuator straight with respect to the caliper body.

2. The brake system of a vehicle as defined in claim 1, wherein the hydraulic piston assembly includes:
a cylinder fixed to the caliper body, sliding straight with respect to the EWB actuator, and having a hydraulic chamber where hydraulic pressure from the outside is exerted; and
a plunger fixed to the EWB actuator to slide straight by the hydraulic pressure in the hydraulic chamber of the cylinder.

3. The brake system of a vehicle as defined in claim 2, further comprising a seal fitted in a seal groove formed at any one of the cylinder and the EWB actuator.

4. The brake system of a vehicle as defined in claim 3, further comprising:
a hydraulic cylinder generating hydraulic pressure by operational force applied to a brake pedal;
a hydraulic line connected to transmit the hydraulic pressure from the hydraulic cylinder to the hydraulic chamber; and
a solenoid valve opening/closing the hydraulic line.

5. The brake system of a vehicle as defined in claim 4, wherein the solenoid valve is formed in a normally-open type that opens the hydraulic line, when control current is not supplied.

6. A vehicle comprising:
two front wheels, each of which comprises the brake system of claim 1,
hydraulic lines configured to supply hydraulic pressure from a hydraulic cylinder to the hydraulic piston assemblies of the wheels, respectively, and
solenoid valves provided in the hydraulic lines, respectively, to independently control the supply of the hydraulic pressure to the hydraulic piston assemblies of the wheels.

7. The brake system of a vehicle as defined in claim 1, further comprising a hydraulic sensor that senses hydraulic pressure exerted in the hydraulic piston assembly.

8. A brake device for a vehicle comprising:
a brake pad movable toward a brake disc and configured to contact the brake disc;
an Electronic Wedge Brake (EWB) device comprising at least one wedge and an actuator configured to push the at least one wedge, wherein the at least one wedge is configured to push the brake pad when the actuator pushes the at least one wedge; and
a hydraulic cylinder comprising a piston coupled to the EWB device and configured to push the EWB device such that the EWB device can push the brake pad without operation of the actuator when the piston pushes the EWB device.

9. The device of claim 8, wherein the brake pad is movable in a first direction toward a brake disc, wherein the actuator is configured to push the at least one wedge in a second direction which is different from the first direction.

10. The device of claim 9, wherein the second direction is inclined relative to the first direction.

11. The device of claim 9, wherein the piston is configured to push the EWB device in the first direction.

12. The device of claim 8, further comprising a circuit configured to operate the piston to push the EWB device in response to an amount of the brake disc's wear.

13. The device of claim 8, further comprising a circuit configured to operate the piston to push the EWB device in response to a signal indicative of failure of the actuator's operation.
